(19) United States
(12) Patent Application Publication
(10) Pub. No.: US 2004/0008432 A1
(43) Pub. Date: Jan. 15, 2004

(54) Accessory rear-view mirror

(76) Inventors: Mariano Shulman, Los Angeles, CA (US); Eva Pous Raventos, Barcelona (ES)

Correspondence Address: STEINBERG & RASKIN, P.C., 1140 AVENUE OF THE AMERICAS, 15th FLOOR, NEW YORK, NY, 10036-5803, US

(21) Appl. No.: 10/191,943

(22) Filed: Jul. 9, 2002

(51) Int. Cl. G02B 5/10

(52) U.S. Cl. 359/871; 359/868

(57) ABSTRACT

In order to increase the field of vision in cars, there are accessory rear-view mirrors that are fitted to a rear support, and are assembled by being placed over and firmly attached to the conventional rear-view mirror. These accessories are well known as having an excessive weight and being attached to the interior rear-view mirror using inadequate means.

The most outstanding characteristic of the accessory rear-view mirror of the invention is the fact that the support is comprised of a sheet that is fixed to the rear side of the mirror, and fitted with a system for attachment to the conventional rear-view mirror. Preferably, the accessory rear-view mirror would have a lower extension in the centre.

### SCOPE OF THE INVENTION

This invention refers to an accessory rear-view mirror to increase the field of vision of the internal rear-view mirror in automobiles.

### BACKGROUND OF THE INVENTION

Interior rear-view mirrors present the inconvenience that their field of vision is not very wide and does not allow a clear view of certain angles to enable the prevention of road accidents.

To date, the accessory rear-view mirrors that are available comprise an oblong mirror of greater length than the conventional rear-view mirror of the vehicle and which are placed over and attached to the rear-view mirror of the vehicle. This system for attachment is troublesome and difficult because of the considerable weight of these accessory rear-view mirrors and the constant handling and adjustment of the means of attachment, which is metallic to be able to support the mirror, acts on the rear-view mirror of the vehicle in such a way that on many occasions it becomes detached.

In order to avoid all this, there are also accessory rear-view mirrors with the support made of plastic material and with a simpler and easier to handle system of attachment to the rear-view mirror of the automobile, but the union of the mirror with the support takes place on the edge of the mirror by means of a lip of the support or profile, and this could be dangerous in the event of breakage of the mirror as any free broken pieces could injure the driver.

Existing accessory rear-view mirrors comply with the objective of widening the field of vision of the driver, but the aforementioned inconveniences make them rather unattractive to possible users, as shown by their lack of popularity among drivers.

### BRIEF SUMMARY OF THE INVENTION

With the accessory rear-view mirror object of the present invention, all these inconveniences or problems are resolved as the support is comprised of a sheet of material, preferably plastic, that considerably reduces the weight of the rear-view mirror and which adheres to the mirror thus preventing any pieces of the mirror becoming loose and causing injury in the event of breakage. The sheet of plastic material is the means of attaching the rear-view mirror to that of the automobile, and could be comprised of simple elastic strips to make fitting fast and easy.

By preference, the accessory rear-view mirror could be convex in shape and offer a wider field of vision without the need to use outside or wing rear-view mirrors, even covering more field of vision than these mirrors, eliminating any blind spots, and the inconvenience of driving using wing or side mounted rear-view mirrors in the event of rain, said convexity enabling the mirrors to be shorter and not limit in any way the visibility of the driver through the front windscreen of the vehicle.

Furthermore, the accessory rear-view mirror may also include a lower extension in the centre to even further extend the field of vision of the driver, this extension being especially indicated for taxi drivers who are obliged to carry passengers in the rear of their vehicles and this would enable them to observe and act accordingly in the event of any strange movements by individuals of uncouth appearance.

These and other characteristics can be better understood from the following detailed description which is also accompanied by a series of drawings showing a practical case and which is intended as an example only and not limiting in any way of the scope of this invention.

### BRIEF DESCRIPTION OF THE DRAWINGS

FIG. 1 is a partially broken away perspective view of the accessory rear-view mirror subject of this invention.

FIG. 2 is a side view along the II-II plane of FIG. 1.

FIG. 3 is a partial schematic view in perspective of a vehicle fitted with the accessory rear-view mirror.

### DETAILED DESCRIPTION OF PREFERRED EMBODIMENTS

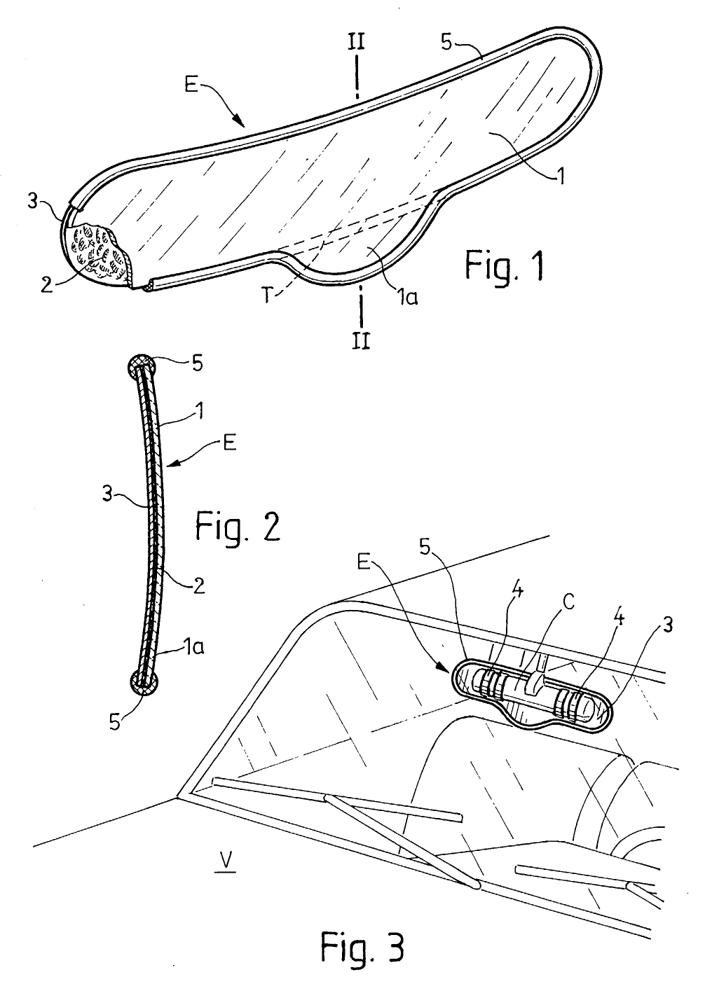

According to the drawings, the accessory rear-view mirror object of this invention, with the general reference —E— comprises a mirror —1— whose front view consists of an oblong configuration with rounded corners and a lower rounded extension in the centre —1a—, the mirror also being convex, and adhered on the back by adhesive —2— (see FIGS. 1 and 2) to a sheet of plastic material —3—, such as methacrylate, that covers the whole rear surface of this part of the mirror.

Between this sheet —3— and the mirror —1— there are pairs of elastic strips —4— attached to the edges of the mirror lying vertically on the rear left and right portions of the sheet —3— and whose ends pass through the edge by upper and lower slits cut into the said parts.

The accessory rear-view mirror —E— is completed by a decorative edging —5— which is fitted around the whole assembly of the mirror —1— and the plastic sheet —3—.

According to this invention, the accessory rear-view mirror —E— is installed in the automobile —V— (FIG. 3) by being placed over the conventional internal rear-view mirror —C—, extending beyond this conventional mirror, especially in the longitudinal direction, the strips —4— are then passed over the and around the ends of the standard rear-view mirror —C—, enabling the accessory rear-view mirror to be mounted and held firmly in place at the same time.

The invention also considers that the accessory rear-view mirror —E— may or may not include the extension 1a, and if said extension is not included the shape of the mirror will be reduced to a rectangular shape limited by the dotted line —T— of FIG. 1, which would then form part of the profile —5—.

1. Accessory rear-view mirror, comprising an oblong mirror firmly fixed by a support to the interior rear-view mirror of automobiles and extending beyond the conventional mirror at least in the longitudinal direction, characterised in that the support is comprised of a sheet which is fixed to the rear part of the mirror, and which is fitted with a means of attachment to the conventional internal rear-view mirror.

2. Accessory rear-view mirror, according to claim 1, characterised in that it presents a lower extension in the centre.

3. Accessory rear-view mirror, according to claims 1 and 2, characterised in that it is convex.
